(19) United States
(12) Patent Application Publication
(10) Pub. No.: US 2025/0320765 A1
(43) Pub. Date: Oct. 16, 2025

(54) Motor Vehicle With an Emergency Opening Mechanism for an Openable Motor Vehicle Window and Method for the Emergency Opening of a Motor Vehicle Window

(71) Applicant: Bayerische Motoren Werke Aktiengesellschaft, Muenchen (DE)

(72) Inventors: Christian BUCHNER, Poing (DE); Holger DIEHL, Muenchen (DE)

(21) Appl. No.: 19/077,198

(22) Filed: Mar. 12, 2025

(30) Foreign Application Priority Data
Apr. 12, 2024 (DE) 10 2024 110 387.6

(51) Int. Cl. E05F 15/77; B60R 25/01; E05B 81/56

(52) U.S. Cl. CPC E05F 15/77; B60R 25/01; B60R 2325/205; E05B 81/56; E05Y 2900/55

(57) ABSTRACT

The present disclosure relates to an emergency opening mechanism for an openable motor vehicle window of a motor vehicle, the motor vehicle having a communication device, a central control unit and a central locking control unit, and the motor vehicle window having an associated window lifter control unit and an associated window lifter actuator. In particular, when an external emergency opening signal is received from a mobile terminal of a user of the motor vehicle and in the event of failure of the central control unit and/or the central locking control unit, the communication device is set up to activate the window lifter control unit for emergency opening of the motor vehicle window by means of the window lifter actuator.

### CROSS REFERENCE TO RELATED APPLICATION

This application claims priority under 35 U.S.C. § 119 from German Patent Application No. 10 2024 110 387.6, filed Apr. 12, 2024, the entire disclosure of which is herein expressly incorporated by reference.

### BACKGROUND AND SUMMARY

The invention relates to a motor vehicle with an emergency opening mechanism for an openable motor vehicle window of the motor vehicle. The invention also relates to a method for the emergency opening of a motor vehicle window of the motor vehicle.

Motor vehicles with electric door access systems are known in the prior art. However, efforts are increasingly being made to eliminate mechanical fallback levels in the form of mechanical keys combined with mechanical locking cylinders in motor vehicle doors in order to achieve cost savings. However, it can happen that a vehicle access control unit or a central control unit of the vehicle cannot be communicated with or does not respond to an authorized vehicle opening command, resulting in the problem that the user can no longer open the door or doors if the vehicle access control unit, which checks access authorization and/or controls the door locks, fails. In such a case, the user or a service employee may have to break a window if the vehicle access control unit fails in order to access the interior of the vehicle and remove or replace the control unit there. This is associated with inconvenience and costs for the user.

In this context, publication WO 2023/006 261 A, for example, discloses a method for the automated control of an electrically operated window in a motor vehicle. In this case, the method comprises (i) a determination, using a sensor arranged on the motor vehicle, as to whether, during a driven movement process of the window, in which a window pane is moved within an associated window frame of the window, a physical object is present in a space between the window pane and the window frame of the window, wherein (ii) the sensor is based on a wireless measurement principle, so that wireless signals, in particular electromagnetic or acoustic signals, characterizing the presence or absence of the object in the space are detected by the sensor during the determination; and (iii) control of the movement process, in particular an opening or closing process, of the window, as a function of the detected presence or absence of the object in the intermediate space.

It is therefore an object of the invention to provide a method that enables access to the motor vehicle in the event of a failure of the vehicle access control unit or the control unit that controls the vehicle door locks.

According to implementations of the invention, this object is achieved by the motor vehicle according to claim 1. Advantageous embodiments of the invention are the subject of the dependent claims and the description. Furthermore, the object is achieved by the method according to the further independent claim.

A motor vehicle according to the technology disclosed herein comprises an emergency opening mechanism for an openable motor vehicle window of the motor vehicle, the motor vehicle having a communication device, a central control unit and a central locking control unit, and the motor vehicle window having an associated window lifter control unit and an associated window lifter actuator. In particular, when an external emergency opening signal is received from a mobile terminal of a user of the motor vehicle and in the event of failure of the central control unit and/or the central locking control unit, the communication device is set up to activate the window lifter control unit for emergency opening of the motor vehicle window by means of the window lifter actuator.

In other words, the motor vehicle comprises a communication device that is set up to communicate wirelessly with a mobile terminal of the user of the motor vehicle or with a backend of the manufacturer. Furthermore, the motor vehicle comprises a central control unit that centrally controls all essential vehicle functions and a central locking control unit that can centrally lock and unlock a door lock. The motor vehicle also comprises a motor vehicle window with an associated window lifter control unit and an associated window lifter actuator. This means that the motor vehicle window can be opened and closed by the user by means of the window lifter actuator, for example by means of an operating device, or can be opened and closed by the central locking control unit or by the central control unit. The motor vehicle can have at least one motor vehicle door with the motor vehicle window and an electrically controllable door opening mechanism, which can be controlled from the central control unit by means of a central locking control unit, wherein in the case of several motor vehicle doors, each door can have a window lifter control unit and an associated window lifter actuator. If the communication device receives an external emergency opening signal from the mobile terminal of the user or from the backend of the manufacturer, the communication device can authenticate the external emergency opening signal in order to ensure the authenticity of the external emergency opening signal. Furthermore, the communication device can send a signal to the central control unit and/or the central locking control unit by means of a data bus in the motor vehicle in order to determine whether the central control unit and/or the central locking control unit are responding communicatively. If the communication device detects and determines that the central control unit and/or the central locking control unit have failed, the communication device can be set up to activate the window lifter control unit for emergency opening or emergency lowering of the motor vehicle window by means of the window lifter actuator. In this case, the instruction for emergency opening of the motor vehicle window can be given by bypassing or without involving the central control unit and without involving the central locking control unit. This means that the communication device sends a signal directly to a door control device or the window lifter control unit in order to open at least one motor vehicle window of the motor vehicle. In this way, redundant vehicle access is achieved by coupling the communication device (the modem control unit) with the control unit that controls the window lifter actuator. If the vehicle access control unit fails, an authorized command can be sent to the modem control unit via this redundant vehicle access using the backend, which forwards this command to the window lifter control unit. This allows the user or a service employee to access the interior of the motor vehicle via the open window and, for example, to open the door using the inside lever or open an engine compartment by operating an engine compartment opening lever. The defective control unit or the control unit that cannot be communicated with can then be removed, repaired, replaced or exchanged.

This means that it is no longer necessary, for example, to smash a window of the motor vehicle in order to access the interior and replace or exchange the control unit.

The invention also comprises further advantageous embodiments, which are explained below.

According to a further advantageous embodiment, it is provided that the motor vehicle window is mounted in a vehicle door with a door control device, the communication device being connected to the door control device via a common data bus and the communication device being able to transmit an authorized command for emergency opening of the motor vehicle window to the window lifter control unit via the door control device without the involvement of the central control unit and/or the central locking control unit. In other words, the communication device has a communication connection or data bus or data line to the door control device or the window lifter control unit, and the window control unit is also connected to the door control device in such a way that it is possible to lower at least one motor vehicle window via the communication device. By means of the common data bus, an instruction for emergency opening of the motor vehicle window can be transmitted without the involvement of the vehicle access control unit or the central control unit.

According to a further advantageous embodiment, it is envisaged that the motor vehicle only (or exclusively) has vehicle doors with a purely electrically controllable door opening mechanism. This means that mechanical locking systems are completely dispensed with in the vehicle doors of the motor vehicle and that there is no mechanical key or locking cylinder in the motor vehicle doors and only digital keys are used. This reduces the cost of mechanical door locking systems and simplifies the production of the motor vehicle.

According to a further advantageous embodiment, it is provided that the external emergency opening signal for emergency opening of the motor vehicle window is discarded by the communication device if the central control unit transmits a response signal to the communication device in response to a request from the communication device within a predetermined period of time, which signals that the central control unit and the central locking control unit have not failed. If, for example, only the central locking control unit has failed, it is possible that the central control unit can be reached via communication so that a signal from the communication device to the central control unit can be answered. However, since the central control unit cannot reach the central locking control unit that has failed, the central control unit can transmit a signal back to the communication device that indicates that the central locking control unit has failed. In turn, the communication device can therefore forward the emergency opening signal for emergency opening of the motor vehicle window to the window lifter control unit, as a failure of the central locking control unit has occurred. However, if both the central control unit and the central locking control unit have not failed, it is not necessary to send the emergency signal and the motor vehicle can be opened in the normal way by the central control unit or the central locking control unit. This means that unintentional opening of the window or non-opening of the central locking system of the motor vehicle can be easily avoided.

According to a further advantageous embodiment of the technology disclosed herein, the door control device is set up to close the motor vehicle window again after a predetermined period of time following the emergency opening of the motor vehicle window. This ensures that if no user interaction can be detected, protection against rain, wind and snow is ensured or that there is sufficient anti-theft protection. Unintentional opening of the motor vehicle window, so that the motor vehicle remains with an open motor vehicle window for a very long time, can therefore be easily avoided.

According to a further advantageous embodiment, the communication device is set up to wirelessly transmit the closed state of the motor vehicle window to the device from which the authorized status request signal was received when a status request signal is received. In this way, a closed state of the motor vehicle window or an open state of the motor vehicle window can simply be transmitted to, for example, the mobile terminal of the user of the vehicle, and the user can make sure that the motor vehicle window is open, for example, and that the request for emergency opening of the motor vehicle window was successful, for example.

According to a further aspect of the invention, there is provided a method for emergency opening a motor vehicle window of a motor vehicle as described above. Here, the method comprises the following steps: receiving an authorized instruction for emergency opening of a motor vehicle window from a mobile terminal of the user of the motor vehicle, determining the failure of the central control unit and/or the central locking control unit, and if the central control unit and/or the central locking control unit have failed, controlling the window lifter control unit for emergency opening of the motor vehicle window. By means of the method, the advantages described above can be obtained in the same way. Furthermore, it is obvious that the further advantageous embodiments of the motor vehicle described above relate to equally advantageous embodiments of the method. The method can be carried out by the communication device or a control unit set up for this purpose.

According to a further advantageous embodiment, it is provided that the instruction for emergency opening of the motor vehicle window is transmitted via a backend of the manufacturer of the motor vehicle. In this case, a backend of the manufacturer is a server infrastructure with server devices of the manufacturer, which are set up to receive an emergency opening command from the mobile terminal of the user, check it, authenticate it and, if necessary, forward it to the motor vehicle. Furthermore, it may be provided that the user of the motor vehicle requests an instruction for emergency opening of the motor vehicle window from the backend of the motor vehicle manufacturer by means of his mobile terminal device, the backend checks and approves this request if all necessary authentication criteria are met, and the backend subsequently transmits the instruction for emergency opening of the motor vehicle window to the motor vehicle. Furthermore, it may be provided that the backend transmits a cryptographic message to the motor vehicle, for example by means of a shared secret with the motor vehicle, in order to authenticate the emergency opening command or the emergency opening instruction for emergency opening of the motor vehicle window. In this way, a particularly secure variant of the method according to the technology described above can be achieved.

According to a further advantageous embodiment, it is provided that after the step of determining the failure of the central control unit and/or the central locking control unit and before the step of actuating the window lifter control unit for emergency opening of the motor vehicle window, the steps described below are additionally carried out: transmitting the information that the central control unit and/or the central locking control unit has failed to the device from which the authorized instruction for emergency opening of the motor vehicle window was received, and continuing the method only upon receipt of a confirmation of the instruction for emergency opening of the motor vehicle window. In other words, the procedure is canceled if a check of the instruction to open the motor vehicle window in an emergency is not confirmed. In this case, the instruction for emergency opening of the motor vehicle window is discarded and the emergency opening is not carried out. This is a simple way of avoiding a false or falsified instruction to open the motor vehicle window in an emergency. In other words, the communication device sends information back to the backend of the manufacturer that vehicle access is disrupted. In response to this information, the user can use the backend to confirm the instruction to open the motor vehicle window in an emergency. The method for emergency opening of the motor vehicle window is only continued accordingly when the confirmation of the instruction is received.

According to a further advantageous embodiment, it is provided that the confirmation of the instruction for emergency opening of the motor vehicle window is issued by the user of the motor vehicle. This means that it is not sufficient for the backend of the manufacturer to send the instruction to open the motor vehicle window in an emergency, but that this instruction must be confirmed and issued by the user of the motor vehicle. This means that incorrect emergency opening of the motor vehicle window can be avoided easily and safely.

Further features of the invention can be found in the claims, the figures and the description of the figures. The features and combinations of features mentioned above in the description as well as the features and combinations of features mentioned below in the description of the figures and/or shown alone in the figures can be used not only in the combination indicated in each case, but also in other combinations or on their own.

The invention will now be explained in greater detail with reference to a preferred exemplary embodiment and with reference to the drawings, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic view of a motor vehicle with an emergency opening mechanism; and

FIG. 2 shows a schematic flow chart of a method according to the technology disclosed herein.

### DETAILED DESCRIPTION OF THE DRAWINGS

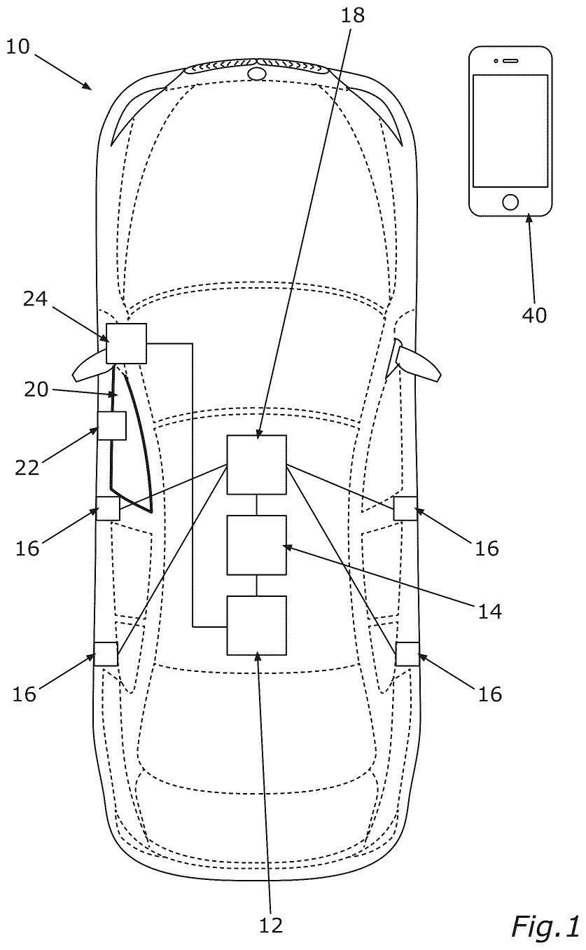

FIG. 1 shows a schematic representation of a motor vehicle 10, which can have a communication device 12, a central control unit 14, door opening mechanisms 16, a central locking control unit 18, at least one motor vehicle window 20, a window lifter control unit 22 and a door control device 24. Furthermore, a mobile device or a mobile terminal 40 is shown. The motor vehicle 10 can be a motor vehicle 10 that only has vehicle doors with a purely electrically controllable door opening mechanism 16. This means that mechanical locking systems can be completely dispensed with and the motor vehicle 10 can only be opened using a digital key system. For this purpose, a mobile terminal 40 can send an authorized command to the motor vehicle 10 in order to unlock the door opening mechanisms 16. This is done via the communication device 12, which is set up to communicate wirelessly via the mobile terminal 40 or to communicate wirelessly with a backend of the manufacturer. The communication device 12 can transmit the command to open the doors to the central control unit 14, which then instructs the central locking control unit 18 to open the door opening mechanisms 16. However, if the central control unit 14 or the central locking control unit 18 does not respond, for example due to an update, an overload, an electronic problem or similar, the central control unit 14 can no longer release the door access. This means that the user or a service employee would have to break and damage a motor vehicle window 20 in order to gain access to the interior of the motor vehicle 10. With the invention, when an external emergency opening signal is received from the mobile terminal 40 of the user of the motor vehicle 10 and if the central control unit 14 and/or the central locking control unit 18 fails, the window lifter control unit 22 can be activated for emergency opening of the motor vehicle window 20 by means of the window lifter actuator. This can be done by bypassing or without involving the central control unit 14 and the central locking control unit 18. Advantageously, however, this is done via the door control device 24. The window lifter control unit 22 is usually used, for example, to implement anti-trap protection for the window lifter actuator. The door control device 24 controls locking or unlocking processes of the door or controls the window lifter control unit 22 or lighting of the vehicle door. The communication device 12 can be connected to the door control device 24 via a common data bus, so that the communication device 12 can transmit an authorized command for emergency opening of the motor vehicle window 20 to the window lifter control unit 22 via the door control device 24 without the involvement of the central control unit and/or the central locking control unit 18. As soon as the motor vehicle window 20 is opened, a service employee can, for example, access the interior of the vehicle and initiate further measures so that a defective control unit can be replaced. Furthermore, the vehicle doors can have purely electrically controllable door opening mechanisms 16. This means that mechanical locking systems can be completely dispensed with and costs can be saved in the manufacture of the vehicle 10.

The communication device 12 is set up to check whether the central control unit 14 or the central locking control unit 18 can be reached for communication. If both devices respond or react and thus no failure of the devices can be detected, the communication device 12 is set up to reject the external emergency opening signal for emergency opening of the motor vehicle window 20 when a request from the communication device 12 to the central control unit 14 and/or the central locking control unit 18 is answered within a predetermined period of time and a response signal is transmitted back to the communication device 12, which signals that the central control unit 14 and the central locking control unit 18 have not failed. If the opening of the motor vehicle window 20 occurs after the instruction for emergency opening of the motor vehicle window 20, the door control device 24 may be arranged to close the motor vehicle window 20 again after a predetermined period of time after the emergency opening of the motor vehicle window 20. This can advantageously provide theft protection or weather protection.

The communication device 12 can be set up to transmit a status request signal of the closing state or the opening state of the motor vehicle 10 back to the device that transmitted the status request signal, for example the mobile terminal 40 of the user of the motor vehicle 10.

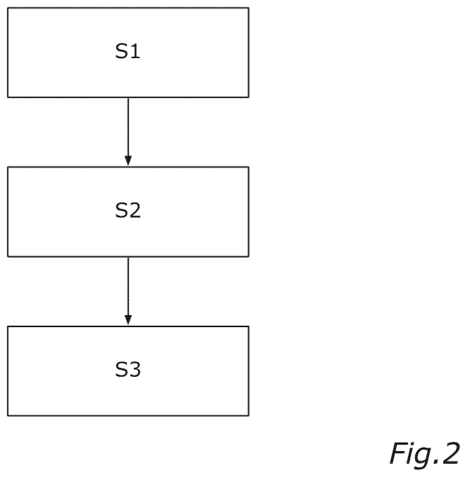

FIG. 2 also shows a method for the emergency opening of a motor vehicle window 20 according to the technology disclosed herein. The following steps are carried out. In a step S1, an authorized instruction for emergency opening of a motor vehicle window 20 is received from a mobile terminal 40 of the user of the motor vehicle 10. The authorized instruction for emergency opening of the motor vehicle window 20 can also be given by means of a backend of a motor vehicle manufacturer. In a step S2, the failure of the central control unit 14 and/or the central locking control unit 18 is determined. This can mean that a failure is detected or determined by the communication device 12 sending a signal to the central control unit 14 or the central locking control unit 18, and if no response signal is sent back from the control units to the communication device 12 within a predetermined period of time, this can signal that the central control unit 14 and the central locking control unit 18 have failed. A failure can be caused, for example, by an update or a power failure and/or an electronic fault in one of the control units.

In the event of failure of the central control unit 14 and/or the central locking control unit 18, the window lifter control unit 22 is activated in step S3 for emergency opening of the motor vehicle window 20. This can be done, for example, by bypassing the central control unit 14 and the central locking control unit 18. In an advantageous manner, however, this can be carried out via the door control device 24.

Between step S2 and step S3, a query can be made to the backend of the manufacturer or to the mobile terminal of the user 40. For this purpose, for example, the information that the central control unit 14 and/or the central locking control unit 18 have failed can be transmitted, and this transmission can be made to the device from which the authorized instruction for emergency opening of the motor vehicle window 20 was received. The method can therefore only be continued if confirmation of the instruction for emergency opening of the motor vehicle window 20 is received from the backend or from the mobile terminal of the user 40. Alternatively, the procedure is aborted at this point if the confirmation is not received. Furthermore, this may include that the confirmation of the instruction for emergency opening of the motor vehicle window 20 must be issued by the user of the motor vehicle 10.

An exemplary embodiment is described below:

New door handle systems allow doors to be opened purely electrically via push-buttons or sensor actuation. This increasingly eliminates mechanical fallback levels in the form of mechanical keys and mechanical locking cylinders in the door.

This results in the problem that the user can no longer open the door if the vehicle access control unit (which checks access authorization and controls the door locks or door opening mechanisms) and/or the control unit that controls the door locks fails. The invention provides a solution to this problem.

If no door locks have mechanical locking cylinders, the user or service employee must, for example, break a window if the vehicle access control unit fails in order to access the interior and remove or replace the control unit.

Redundant vehicle access is created by coupling the communication device 12 (“modem” control unit) with the control unit that controls the window lifter motors. If the vehicle access control unit fails, an authorized command can be sent via the redundant path using the backend to the communication device 12, which forwards the command to the window lifter control unit 22. As a result, the user or service employee can access the interior of the motor vehicle 10 through the open motor vehicle window 20 and, for example, can open a door using an inside lever.

So if the user of the motor vehicle 10 finds that he can no longer open the vehicle, he can, for example, contact a service hotline and request an authorized opening of the vehicle door. This can result in an opening command being sent to the communication device 12 via the backend. As a result, the communication device 12 can attempt to wake up the vehicle access control unit in order to forward the authorized opening command.

However, if the vehicle access control unit has failed, it will not respond. As a result, the communication device 12 sends the information back to the backend that “vehicle access is disrupted”. The service can then ask the user whether an emergency opening of the window is required, who then requests this. As a result, a “window emergency lowering” command is sent via the backend to the communication device 12 in the motor vehicle 10. The communication device 12 can be connected to the window lifter control unit 22 via a common data bus and can thus transmit an authorized command for emergency lowering of a window to the window lifter control unit 22 without the involvement of the vehicle access control unit. After the window has been lowered, the user or a service technician or service employee can either reach into or enter the motor vehicle 10 and open the door by pulling an emergency release inside the motor vehicle 10 and, in the next step, can replace the defective vehicle access control unit.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

10 motor vehicle
12 communication device
14 control unit
16 door opening mechanism
18 central locking control unit
20 motor vehicle window
22 window lifter control unit
24 door control device
40 terminal device

What is claimed is:

1. A motor vehicle with an emergency opening mechanism for an openable motor vehicle window of the motor vehicle, the motor vehicle comprising:
a communication device;
a central control unit;
a central locking control unit; and
the motor vehicle window comprising:
a window lifter control unit; and
a window lifter actuator,
wherein the communication device, on receiving an external emergency opening signal from a mobile terminal of a user of the motor vehicle and in the event of failure of at least one of the central control unit or the central locking control unit, is configured to activate the window lifter control unit for emergency opening of the motor vehicle window by means of the window lifter actuator.

2. The motor vehicle of claim 1, wherein:
the motor vehicle window is mounted in a vehicle door with a door control device;
the communication device is connected to the door control device via a common data bus; and
the communication device is configured to transmit an authorized command for emergency opening of the motor vehicle window to the window lift control unit via the door control device without the involvement of at least one of the central control unit or the central locking control unit.

3. The motor vehicle of claim 1, wherein the motor vehicle comprises only vehicle doors with a purely electrically controllable door opening mechanism.

4. The motor vehicle of claim 1, wherein the external emergency opening signal for emergency opening of the motor vehicle window is rejected by the communication device when the central control unit transmits a response signal to the communication device in response to a request from the communication device within a predetermined period of time, signaling that the central control unit and the central locking control unit have not failed.

5. The motor vehicle of claim 1, wherein the door control device is configured to close the motor vehicle window again after a predetermined period of time after the emergency opening of the motor vehicle window.

6. The motor vehicle of claim 1, wherein the communication device is configured to wirelessly transmit back the closed state of the motor vehicle window when a status request signal is received.

7. A method for emergency opening a motor vehicle window of the motor vehicle according to claim 1, the method comprising:
receiving an authorized instruction for emergency opening of a motor vehicle window from a mobile terminal of the user of the motor vehicle;
determining the failure of at least one of the central control unit or the central locking control unit; and
when at least one of the central control unit or the central locking control unit have failed, activating the window lifter control unit for emergency opening of the motor vehicle window.

8. The method of claim 7, wherein the instruction for emergency opening of the motor vehicle window is transmitted via a backend of the manufacturer of the motor vehicle.

9. The method of claim 7, wherein the following steps are additionally carried out after the step of determining the failure of at least one of the central control unit or the central locking control unit and before the step of activating the window lifter control unit for emergency opening of the motor vehicle window:
transmitting the information that at least one of the central control unit or the central locking control unit have failed to the device from which the authorized instruction for emergency opening of the motor vehicle window was received; and
continuing the method only upon receipt of a confirmation of the instruction to open the motor vehicle window in an emergency.

10. The method according to claim 9, wherein the confirmation of the instruction for emergency opening of the motor vehicle window is given by the user of the motor vehicle.
